(19) United States
(12) Patent Application Publication
(10) Pub. No.: US 2026/0180626 A1
(43) Pub. Date: Jun. 25, 2026

(54) MULTI-CHANNEL DIGITAL CONTROL RADIO FREQUENCY SWITCH CHIP AND METHOD FOR APPLYING SAME

(71) Applicant: TSINGHUA UNIVERSITY, Beijing (CN)

(72) Inventors: Fan YANG, Beijing (CN); Yifei JIN, Beijing (CN); Hao SHI, Beijing (CN); Shenheng XU, Beijing (CN); Maokun LI, Beijing (CN)

(21) Appl. No.: 19/280,153

(22) Filed: Jul. 25, 2025

(30) Foreign Application Priority Data
Dec. 24, 2024 (CN) 202411913078.2

(51) Int. Cl. H04B 7/04; H04B 7/06

(52) U.S. Cl. CPC H04B 7/04013; H04B 7/0602

(57) ABSTRACT

The present disclosure relates to a multi-channel digital control radio frequency switch chip and a method for applying same. The chip includes a digital control module, a storage module, and a radio frequency switch phase shift module. The digital control module is configured to read first code table information from the storage module or write second code table information into the storage module based on a digital signal input from the digital signal input port. The storage module is configured to store the first code table information and the second code table information. The radio frequency switch phase shift module is configured to control, based on the first code table information or the second code table information, an operation state of a radio frequency device connected to the plurality of radio frequency output ports.

### CROSS-REFERENCE TO RELATED APPLICATIONS

This application claims priority to Chinese Patent Application No. 202411913078.2, filed on Dec. 24, 2024, which is incorporated herein by reference in its entirety.

### FIELD

The present disclosure relates to the field of chip technologies, and particularly, to a multi-channel digital control radio frequency switch chip and a method for applying a multi-channel digital control radio frequency switch chip.

### BACKGROUND

A reconfigurable intelligent metasurface, as a new phased array antenna, is composed of arranged and combined antenna units. By applying control signals to switch devices integrated onto the antenna units, operation modes of these electromagnetic units can be dynamically controlled. However, quantization errors introduced by 1-bit phase quantization or 2-bit phase quantization lead to performance degradation in terms of a metasurface antenna, such as gain, radiation pattern sidelobes, and bandwidth. Moreover, for conventional control methods, a quantization degree of freedom is realized based on a spatial dimension through switch hardware.

### SUMMARY

The present disclosure provides a multi-channel digital control radio frequency switch chip and a method for applying a multi-channel digital control radio frequency switch chip, to address problems of high power consumption when using a PIN diode as a switch in a reconfigurable intelligent metasurface and of high complexity and a large quantization loss when employing a plurality of independent switches in a large-scale reconfigurable antenna.

Embodiments of the present disclosure provide a multi-channel digital control radio frequency switch chip. The multi-channel digital control radio frequency switch chip includes a digital control module, a storage module, and a radio frequency switch phase shift module. The digital control module has a first terminal connected to a digital signal input port and a second terminal connected to a first terminal of the storage module. The digital control module is configured to read first code table information from the storage module or write second code table information into the storage module based on a digital signal input from the digital signal input port. The storage module is configured to store the first code table information and the second code table information. The radio frequency switch phase shift module has a plurality of radio frequency output ports, the radio frequency switch phase shift module is connected to a third terminal of the digital control module and a second terminal of the storage module. The radio frequency switch phase shift module is configured to control, based on the first code table information or the second code table information, an operation state of a radio frequency device connected to the plurality of radio frequency output ports.

In some embodiments, the digital signal includes at least one of a data signal, a clock signal, a reset signal, or an enable signal.

In some embodiments, a waveform of the digital signal includes a frame header, an instruction code, an address bit of the storage module, a data bit, and a frame trailer.

In some embodiments, the operation state includes a reflection amplitude and phase of a radio frequency signal.

In some embodiments, the digital control module, the storage module, and the radio frequency switch phase shift module are integrally arranged.

In some embodiments, the radio frequency switch phase shift module is fabricated using a Complementary Metal Oxide Semiconductor (CMOS) technology.

The embodiments of the present disclosure further provide a method for applying a multi-channel digital control radio frequency switch chip. The method includes: constructing a phased array antenna based on the multi-channel digital control radio frequency switch chip, and controlling, based on a plurality of pieces of code table information corresponding to a same-direction beam, the phased array antenna to radiate during a plurality of continuous time periods with a same interval, where the phased array antenna is a 1-bit phased array; controlling, based on the plurality of pieces of code table information, an antenna unit in the phased array antenna to switch between a first phase shift state and a second phase shift state within the plurality of continuous time periods with the same interval to form a plurality of radiation patterns; and merging the plurality of radiation patterns into an equivalent multi-bit radiation pattern based on a time-averaged processing approach.

In some embodiments, the multi-channel digital control radio frequency switch chip is at least one of a microwave band chip, a millimeter-wave band chip, or a terahertz band chip.

In some embodiments, the first phase shift state is a 0° phase shift state.

In some embodiments, the second phase shift state is a 180° phase shift state.

In the above embodiments, the digital control module is used to read the first code table information from the storage module or write the second code table information into the storage module based on the digital signal input from the digital signal input port. The operation state of the radio frequency device connected to the plurality of radio frequency output ports is controlled by the radio frequency switch phase shift module based on the first code table information or the second code table information. Therefore, the present disclosure addresses the problems of the high power consumption when using the PIN diode as the switch in the reconfigurable intelligent metasurface and of the high complexity and the large quantization loss when employing the plurality of independent switches in the large-scale reconfigurable antenna. In this way, an integration level of an antenna design can be further improved for an application in a design of a new phased array antenna. By utilizing a spatio-temporal digital signal, the phased array antenna is capable of performing beam scanning, sidelobe reduction, main lobe interference resistance, and other operations, enhancing a gain and radiation pattern performance of a metasurface antenna.

Additional aspects and advantages of the present disclosure will be provided at least in part in the following description, or in part will become apparent from the following description or can be learned from practicing of the present disclosure.

### BRIEF DESCRIPTION OF THE DRAWINGS

The above and/or additional aspects and advantages of the present disclosure will become apparent and understandable from the following description of embodiments taken in conjunction with the accompanying drawings.

FIG. 1 is a schematic diagram of a multi-channel digital control radio frequency switch chip according to an embodiment of the present disclosure.

FIG. 2 is a schematic waveform diagram showing storing a code table into a memory according to an embodiment of the present disclosure.

FIG. 3 is a schematic waveform diagram showing reading a code table from a memory according to an embodiment of the present disclosure.

FIG. 4 is an exemplary diagram of a method for applying a multi-channel digital control radio frequency switch chip according to an embodiment of the present disclosure.

FIG. 5 is a schematic diagram showing implementing equivalent 3-bit phase shifting using a 1-bit switch according to an embodiment of the present disclosure.

FIG. 6 is a radiation pattern result showing a sidelobe reduction according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than construed as limiting, the present disclosure.

A multi-channel digital control radio frequency switch chip and a method for applying multi-channel digital control radio frequency switch chip according to the embodiments of the present disclosure are described below with reference to the accompanying drawings. To address the problems mentioned in the background of the high power consumption when using the PIN diode as the switch in the reconfigurable intelligent metasurface and of the high complexity and the large quantization loss when employing the plurality of independent switches in the large-scale reconfigurable antenna, the present disclosure provides a multi-channel digital control radio frequency switch chip. A digital control module is used to read first code table information from a storage module or write second code table information into the storage module based on a digital signal input from a digital signal input port. An operation state of a radio frequency device connected to a plurality of radio frequency output ports is controlled by a radio frequency switch phase shift module based on the first code table information or the second code table information. Therefore, the present disclosure addresses the problems of the high power consumption when using the PIN diode as the switch in the reconfigurable intelligent metasurface and of the high complexity and the large quantization loss when employing the plurality of independent switches in the large-scale reconfigurable antenna. In this way, an integration level of an antenna design can be further improved for an application in a design of a new phased array antenna. By utilizing a spatio-temporal digital signal, the phased array antenna is capable of performing beam scanning, sidelobe reduction, main lobe interference resistance, and other operations, enhancing a gain and radiation pattern performance of a metasurface antenna.

Problems to be solved by the embodiments of the present disclosure are as follows. (1) In a design of a reconfigurable intelligent metasurface, a PIN diode is commonly used as a switch, leading to high power consumption that is not conducive to practical applications. (2) In a design of a large-scale reconfigurable antenna, using a plurality of independent switches leads to high complexity. (3) Due to characteristics of currently commonly used switches, a 2-bit design of a reconfigurable antenna requires a plurality of switches, while a 1-bit design suffers from a large quantization loss. Therefore, there is an urgent need for a switch that can achieve high integration while reducing both power consumption and quantization loss.

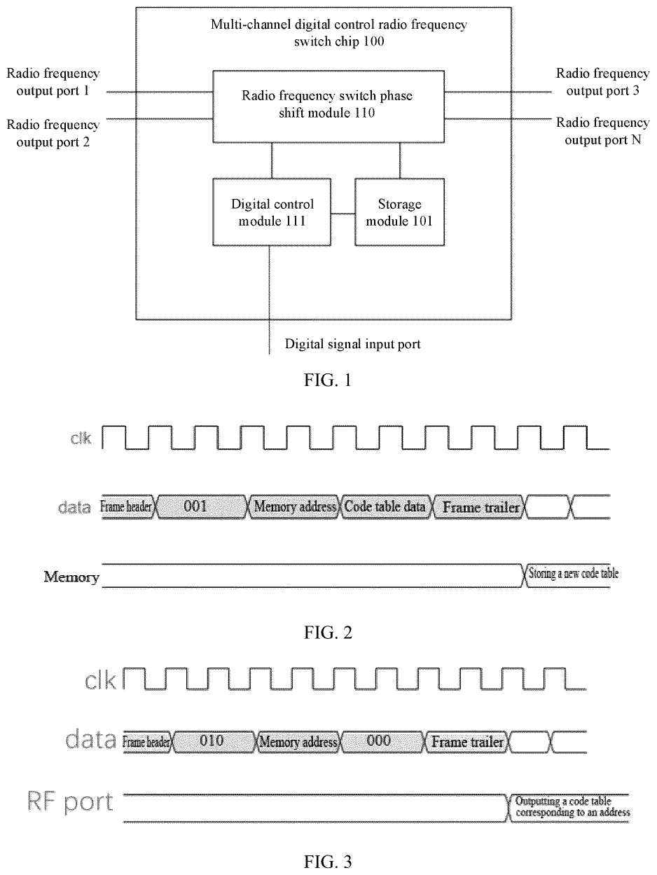

Specifically, FIG. 1 is a schematic diagram of a multi-channel digital control radio frequency switch chip according to an embodiment of the present disclosure.

As illustrated in FIG. 1, a multi-channel digital control radio frequency switch chip 100 includes a digital control module 111, a storage module 101, and a radio frequency switch phase shift module 110. The multi-channel digital control radio frequency switch chip 100 is applied in a design scenario of a phased array antenna.

The digital control module 111 has a first terminal connected to a digital signal input port and a second terminal connected to a first terminal of the storage module 101. The digital control module 111 is configured to read first code table information from the storage module 101 or write second code table information into the storage module 101 based on a digital signal input from the digital signal input port. The storage module 101 is configured to store the first code table information and the second code table information. The radio frequency switch phase shift module 110 has a plurality of radio frequency output ports. The radio frequency switch phase shift module 110 is connected to a third terminal of the digital control module 111 and a second terminal of the storage module 101. The radio frequency switch phase shift module 110 is configured to control, based on the first code table information or the second code table information, an operation state of a radio frequency device connected to the plurality of radio frequency output ports.

In some embodiments, the digital signal includes at least one of a data signal, a clock signal, a reset signal, or an enable signal.

In some embodiments, a waveform of the digital signal includes a frame header, an instruction code, an address bit of the storage module, a data bit, and a frame trailer.

In some embodiments, the operation state includes a reflection amplitude and phase of a radio frequency signal.

In some embodiments, the digital control module 111, the storage module 101, and the radio frequency switch phase shift module 110 are integrally arranged.

In some embodiments, the radio frequency switch phase shift module 110 is fabricated using a Complementary Metal Oxide Semiconductor (CMOS) technology.

Specifically, as illustrated in FIG. 1, the digital control module 111 has the first terminal connected to the digital signal input port and the second terminal connected to the first terminal of the storage module 101. The radio frequency switch phase shift module 110 is connected to the third terminal of the digital control module 111 and the second terminal of the storage module 101. The digital control module 111 is connected to an input signal bus containing a data signal Data, a clock signal Clk, a reset signal Reset, an enable signal Enable, etc. The radio frequency switch phase shift module 110 is connected to N radio frequency output ports, where N is an integer greater than 1. For ease of illustration of the embodiments of the present disclosure, N is taken as 4. When the multi-channel digital control radio frequency switch chip 100 performs a read operation or a write operation on the storage module 101, waveforms of the input clock signal Clk and the input data signal Data are as illustrated in FIG. 2 and FIG. 3. A complete data waveform includes a frame header, an instruction code (e.g., 001 represents writing, 010 represents reading), an address bit of the storage module 101 (an address of a target memory for reading or writing), a data bit (code table data when writing, and all zeros when reading), and a frame trailer. During the read operation or the write operation on the storage module 101, state changes of a corresponding storage unit in the storage module 101 and Data waveforms are as illustrated in FIG. 2 and FIG. 3. After identifying the frame header to the frame trailer, the digital control module 111 writes into a corresponding address of the storage module 101 based on decoded information, in such a manner that the second code table information in the Data waveform is stored in the storage module 101; or the digital control module 111 reads from the corresponding address of the storage module 101 based on the decoded information, and thus the corresponding first code table information is output. The radio frequency switch phase shift module 110 controls, based on the first code table information or the second code table information, the operation state of the radio frequency device connected to the plurality of radio frequency output ports.

The multi-channel digital control radio frequency switch chip can be widely applied in a phased array unit design or array control in a microwave band, a millimeter-wave band, or a terahertz band.

In summary, advantageous effects achieved by implementing the embodiments of the present disclosure are as follows.
(1) Applying the CMOS technology in the radio frequency switch module can effectively reduce direct current power consumption. In addition, a voltage-controlled characteristic can simplify a direct current bias circuit.
(2) By integrally arranging a multi-channel phase shift unit in a single chip using a chip technology, and in combination with the digital control module and the storage module, system complexity can be effectively reduced.
(3) By integrating the storage module and using the waveform of the input digital signal for beam switching control, high-speed switching can be achieved.

With the multi-channel digital control radio frequency switch chip according to the embodiments of the present disclosure, the digital control module is used to read the first code table information from the storage module or write the second code table information into the storage module based on the digital signal input from the digital signal input port. The operation state of the radio frequency device connected to the plurality of radio frequency output ports is controlled by the radio frequency switch phase shift module based on the first code table information or the second code table information. Therefore, the present disclosure addresses the problems of the high power consumption when using the PIN diode as the switch in the reconfigurable intelligent metasurface and of the high complexity and the large quantization loss when employing the plurality of independent switches in the large-scale reconfigurable antenna. In this way, the integration level of the antenna design can be further improved for the application in the design of the new phased array antenna. By utilizing the spatio-temporal digital signal, the phased array antenna is capable of performing the beam scanning, the sidelobe reduction, the main lobe interference resistance, and other operations, enhancing the gain and the radiation pattern performance of the metasurface antenna.

A method for applying the multi-channel digital control radio frequency switch chip according to the embodiments of the present disclosure is described below with reference to the accompanying drawings.

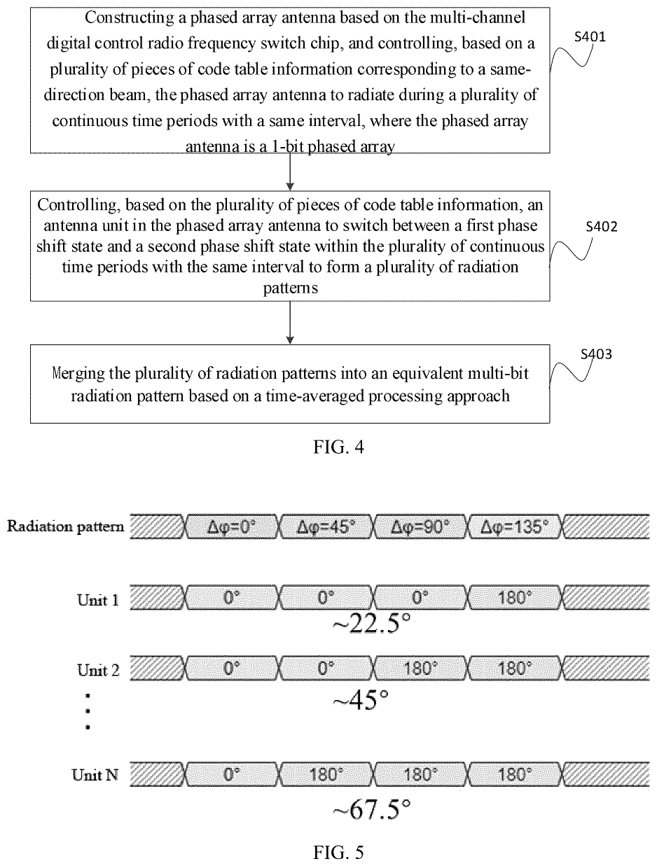

FIG. 4 is a schematic diagram of a method for applying a multi-channel digital control radio frequency switch chip according to an embodiment of the present disclosure.

As illustrated in FIG. 4, the method for applying the multi-channel digital control radio frequency switch chip includes the following operations at blocks.

At block S401, a phased array antenna is constructed based on the multi-channel digital control radio frequency switch chip, and the phased array antenna is controlled, based on a plurality of pieces of code table information corresponding to a same-direction beam, to radiate during a plurality of continuous time periods with a same interval, where the phased array antenna is a 1-bit phased array.

At block S402, an antenna unit in the phased array antenna is controlled, based on the plurality of pieces of code table information, to switch between a first phase shift state and a second phase shift state within the plurality of continuous time periods with the same interval to form a plurality of radiation patterns.

At block S403, the plurality of radiation patterns are merged into an equivalent multi-bit radiation pattern based on a time-averaged processing approach.

In some embodiments, the multi-channel digital control radio frequency switch chip is at least one of a microwave band chip, a millimeter-wave band chip, and a terahertz band chip.

In some embodiments, the first phase shift state is a 0° phase shift state.

In some embodiments, the second phase shift state is a 180° phase shift state.

It should be understood that, through an introduction of a degree of freedom in a time dimension according to the embodiments of the present disclosure, the radio frequency switch chip can achieve equivalent high-precision phase quantization and phase shifting based on low-precision phase quantization and phase shifting of hardware and in combination with the time dimension. Therefore, system complexity, costs, and power consumption are reduced.

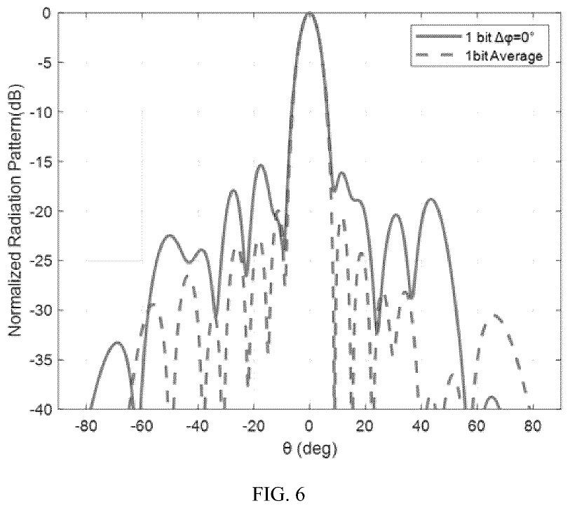

Specifically, during control of a radiation pattern of the phased array, equivalent multi-bit quantization can be achieved by introducing the degree of freedom in the time dimension. The phased array antenna is constructed based on the multi-channel digital control radio frequency switch chip. As illustrated in FIG. 5, during transmission by the phased array antenna, the 1-bit phased array is controlled, based on four code tables corresponding to the same-direction beam, to radiate during four continuous time periods with a same interval, i.e., Δφ=0°, Δφ=45°, Δφ=90°, and Δφ=135°. Within each time period, each unit operates in the 0° phase shift state or the 180° phase shift state based on the code table. For example, Unit 1 operates in the 0° phase shift state during the first three time periods and in the 180° phase shift state during the fourth time period. After a receiving end receives these four radiation patterns, an equivalent 3-bit radiation pattern can be obtained through the time-averaged processing approach. In this way, phase shifting of Unit 1 becomes equivalent to 22.5°, and similarly, phase shifting of Unit N becomes equivalent to 67.5°, achieving an effect of reducing sidelobes of the radiation pattern. The radiation pattern obtained and processed by the receiving end is illustrated in FIG. 6. Compared with an original radiation pattern, the time-averaged radiation pattern can effectively reduce the sidelobes.

Similar to the above embodiments, the spatio-temporal digital signal enables, in combination with the degree of freedom in the time dimension, the phased array to achieve functionalities such as equivalent multi-bit, low sidelobes, and main lobe interference resistance.

In summary, advantageous effects achieved by implementing the embodiments of the present disclosure are as follows.
(1) Based on 1-bit phase shifting in switch hardware, introducing (n−1)-bit of degree of freedom in the time domain through a time-modulated signal enables equivalent n-bit phase shifting, reducing a quantization loss.
(2) By combining the radio frequency switch chip with the time-modulated signal to control a reconfigurable antenna array, multifunctional applications such as low sidelobes, beam scanning, and main lobe interference resistance can be realized.

With the method for applying the multi-channel digital control radio frequency switch chip according to the embodiments of the present disclosure, the phased array antenna is constructed based on the multi-channel digital control radio frequency switch chip, and the phased array antenna is controlled, based on the plurality of pieces of code table information corresponding to the same-direction beam, to radiate during the plurality of continuous equal-interval time periods. The antenna unit in the phased array antenna is controlled based on the plurality of pieces of code table information to switch between the first phase shift state and the second phase shift state within the plurality of continuous equal-interval time periods to form the plurality of radiation patterns. The plurality of radiation patterns are merged into the equivalent multi-bit pattern based on the time-averaged processing approach. Therefore, the present disclosure addresses the problems of the high power consumption when using the PIN diode as the switch in the reconfigurable intelligent metasurface and of the high complexity and the large quantization loss when employing the plurality of independent switches in the large-scale reconfigurable antenna. In this way, the integration level of the antenna design can be further improved for the application in the design of the new phased array antenna. By utilizing the spatio-temporal digital signal, the phased array antenna is capable of performing the beam scanning, the sidelobe reduction, the main lobe interference resistance, and other operations, enhancing the gain and the pattern performance of the metasurface antenna.

In the description of this specification, descriptions with reference to the terms “an embodiment”, “some embodiments”, “examples”, “specific examples”, or “some examples” etc., mean that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or N embodiments or examples in a suitable manner. In addition, those skilled in the art can combine the different embodiments or examples and the features of the different embodiments or examples described in this specification without contradicting each other.

In addition, the terms “first” and “second” are only used for descriptive purposes, and cannot be understood as indicating or implying relative importance or implicitly indicating the number of indicated technical features. Therefore, the features defined with “first” and “second” may explicitly or implicitly include at least one of the features. In the description of the present disclosure, “N” means at least two, such as two, three, etc., unless otherwise specifically defined.

Any process or method described in a flowchart or described herein in other ways may be construed as including one or N modules, segments, or portions of codes of executable instructions for achieving specific logical functions or steps in the process. The scope of a preferred embodiment of the present disclosure includes other implementations. A function may be performed not in a sequence shown or discussed, including a substantially simultaneous manner or a reverse sequence based on the function involved, which should be understood by those skilled in the art to which the embodiments of the present disclosure belong.

What is claimed is:

1. A multi-channel digital control radio frequency switch chip, comprising a digital control module, a storage module, and a radio frequency switch phase shift module, wherein:
the digital control module has a first terminal connected to a digital signal input port and a second terminal connected to a first terminal of the storage module, and the digital control module is configured to read first code table information from the storage module or write second code table information into the storage module based on a digital signal input from the digital signal input port;
the storage module is configured to store the first code table information and the second code table information; and
the radio frequency switch phase shift module has a plurality of radio frequency output ports, the radio frequency switch phase shift module is connected to a third terminal of the digital control module and a second terminal of the storage module, and the radio frequency switch phase shift module is configured to control, based on the first code table information or the second code table information, an operation state of a radio frequency device connected to the plurality of radio frequency output ports.

2. The multi-channel digital control radio frequency switch chip according to claim 1, wherein the digital signal comprises at least one of a data signal, a clock signal, a reset signal, or an enable signal.

3. The multi-channel digital control radio frequency switch chip according to claim 1, wherein a waveform of the digital signal comprises a frame header, an instruction code, an address bit of the storage module, a data bit, and a frame trailer.

4. The multi-channel digital control radio frequency switch chip according to claim 1, wherein the operation state comprises a reflection amplitude and phase of a radio frequency signal.

5. The multi-channel digital control radio frequency switch chip according to claim 1, wherein the digital control module, the storage module, and the radio frequency switch phase shift module are integrally arranged.

6. The multi-channel digital control radio frequency switch chip according to claim 1, wherein the radio frequency switch phase shift module is fabricated using a Complementary Metal Oxide Semiconductor (CMOS) technology.

7. A method for applying a multi-channel digital control radio frequency switch chip, the method comprising:
constructing a phased array antenna based on the multi-channel digital control radio frequency switch chip, and controlling, based on a plurality of pieces of code table information corresponding to a same-direction beam, the phased array antenna to radiate during a plurality of continuous time periods with a same interval, where the phased array antenna is a 1-bit phased array;
controlling, based on the plurality of pieces of code table information, an antenna unit in the phased array antenna to switch between a first phase shift state and a second phase shift state within the plurality of continuous time periods with the same interval to form a plurality of radiation patterns; and
merging the plurality of radiation patterns into an equivalent multi-bit radiation pattern based on a time-averaged processing approach.

8. The method according to claim 7, wherein the multi-channel digital control radio frequency switch chip is at least one of a microwave band chip, a millimeter-wave band chip, or a terahertz band chip.

9. The method according to claim 7, wherein the first phase shift state is a 0° phase shift state.

10. The method according to claim 7, wherein the second phase shift state is a 180° phase shift state.
